(19) United States
(12) Patent Application Publication
(10) Pub. No.: US 2017/0175363 A1
(43) Pub. Date: Jun. 22, 2017

(54) METHOD FOR PROVIDING IMAGES OF A WORK TOOL FOR A MACHINE

(71) Applicant: Caterpillar Inc., Peoria, IL (US)

(72) Inventor: Bryan J. Clarke, Bloomingdale, IL (US)

(73) Assignee: Caterpillar Inc., Peoria, IL (US)

(21) Appl. No.: 14/977,744

(22) Filed: Dec. 22, 2015

(51) Int. Cl. E02F 9/26; G05D 1/00

(52) U.S. Cl. CPC E02F 9/26; G05D 1/0094

(57) ABSTRACT

A method of providing a vantage of a work tool. The method comprises positioning an unmanned aerial vehicle with respect to a machine such that a camera carried by the aerial vehicle has a vantage of a work tool associated with the machine. The camera is configured to capture the image of the work tool. Images captured by the camera are displayed to the operator of the machine.

### TECHNICAL FIELD

The present disclosure relates generally to a machine. In particular, the present disclosure relates to a method for operating a machine having an unmanned aerial vehicle to provide images of machine surroundings to an operator.

### BACKGROUND

Work machines are used for executing various tasks on work sites. The work machines may include work tools or implements such as buckets, scooper, blades, backhoe, lift forks, etc. for performing operations. The work machines typically have an operator cabin, through which the operator views the work environment and the work tool to control operation of the work machine. The operator cabin includes windows so that the operator can visualize the work tool. However, the operator may not get a clear view of the work tool and the work tool surroundings from the operator cabin. In work machines such as wheel loaders, components impairing visibility include cab dashboard, limited window size, tilt cylinders, tilt pins, lift arms, and the work tool itself.

A camera mounted on the machine and a display unit remotely connected with the camera may be used to view the work tool and its surroundings. However, the camera has a limited scope of vision and the front view of the work tool is generally not visible. Further, there are certain blind spots that are not visible using cameras. The operator may not be able to get a complete vision of the work tool and may need to step out of the machine or may need a spotter on the ground to check the status and condition of the work tool. This may be burdensome for the operator or require additional manpower.

JP published application No. 2006180326 discloses a drone vision system for an automobile. The drone vision system includes a drone and provides images of road in the vicinity of the automobile by moving the drone around the vehicle.

### SUMMARY OF THE INVENTION

In an aspect of the present disclosure, a method of providing vantage of the work tool is disclosed. The method includes positioning an unmanned aerial vehicle with respect to a machine such that a camera carried by the unmanned aerial vehicle has a vantage of a work tool associated with the machine, capturing an image of the work tool using the camera and displaying the image to an operator of the machine.

In another aspect of the present disclosure, a machine is disclosed. The machine includes a work tool, an unmanned aerial vehicle positioned with respect to the machine such that a camera carried by the unmanned aerial vehicle has a vantage of the work tool associated with the machine, wherein the camera is configured to capture an image of the work tool, a display unit to display the image to an operator of the machine and a controller communicably coupled to the unmanned aerial vehicle. The controller is configured to launch the unmanned aerial vehicle from the machine. The operator determines a position of the unmanned aerial vehicle relative to the machine such that the camera carried by the unmanned aerial vehicle has a vantage of the work tool associated with the machine. The controller is further configured to display the images of the work tool to the operator through the display unit.

### BRIEF DESCRIPTION OF THE DRAWINGS

FIG. 1 illustrates a side view of a machine in accordance with an embodiment of the disclosure.

FIG. 2 illustrates inside view of an operator cabin for the machine in accordance with an embodiment of the disclosure.

FIG. 3 illustrates a method for operating a machine in accordance with an embodiment of the disclosure.

### DETAILED DESCRIPTION

Reference will now be made in detail to the embodiments of the invention, examples of which are illustrated in the accompanying drawings. Wherever possible, the same reference number will be used throughout the drawings to refer to the same or like parts.

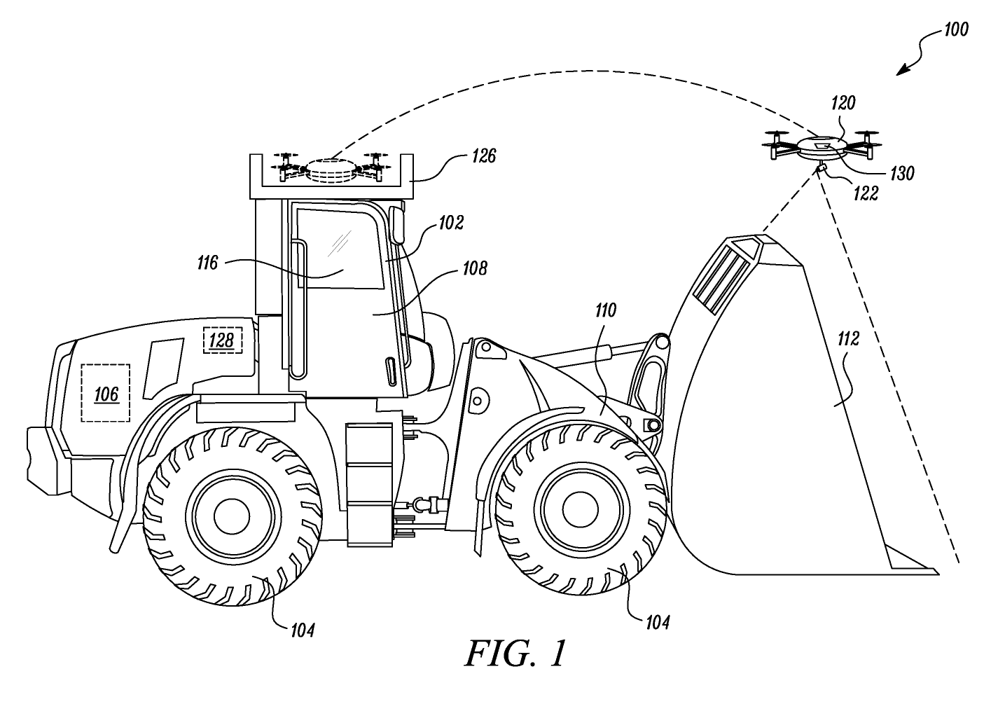

FIG. 1 illustrates a machine 100 in accordance with the present disclosure. The machine 100 may be used to perform various operations at a work site such as transportation, loading or surface altering and the like. The machine 100 may be any machine such as wheel loader (shown in FIG. 1), dozers, motor graders, compactors, pavers and profilers. These machines are usually powered by mechanical, chemical, thermal or electrical means, and are often motorized.

As shown in FIG. 1, the machine 100 may include a frame 102 which supports traction devices 104, an engine 106, and an operator cabin 108. The engine 106 may be supported on the frame 102 provides power to the traction devices 104 and other components of the machine 100. The engine 106 may be a spark ignited engine or a compression ignition engine. In various embodiments, one may also contemplate that the engine 106 may be any engine 106 running on solid, liquid or gaseous fuel and the like.

The machine 100 may further include a pair of lift arms 110 that are movably coupled to the frame 102 at one end. A work tool 112 may be attached to the pair of lift arms 110. The work tool 112 may be attached to the pair of lift arms 110 by any suitable coupling means such as but not limited to a pin, a coupler etc. In the embodiment illustrated, the work tool 112 is an oversized bucket for moving material. Although, the oversized sized bucket is shown, bucket of any size and dimension can also be used. In various embodiments, one may also contemplate that work tool 112 may be any tool used in the performance of a work-related task. For example, work tools may include one or more of a blade, a shovel, a ripper, a dump bed, a fork arrangement, a broom, a grasping device, a cutting tool, a digging tool, a propelling tool, or any other task-performing tool known in the art. The work tool 112 may be operated by an operator sitting in the operator cabin 108.

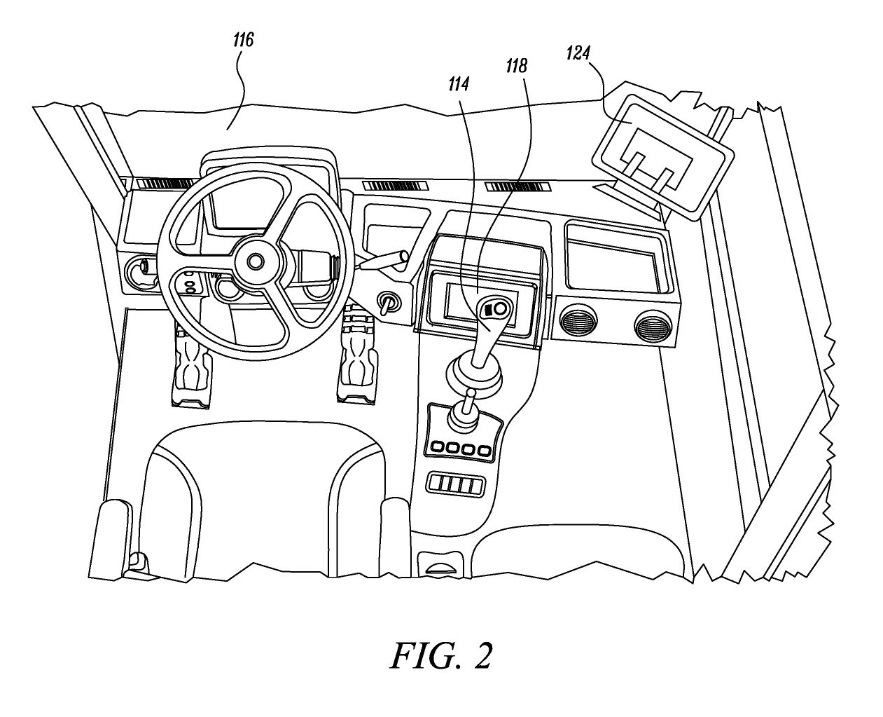

The operator cabin 108 may include an operator interface 114 (shown in FIG. 2) through which an operator may be able to operate the pair of lift arms 110, the work tool 112, and the like. The operator interface 114 may be a joystick, a touch screen, a lever or any other suitable device. The operator interface 114 may be operated by an operator, and in response, produce signals corresponding to the requested machine function. The operator cabin 108 may further includes window 116 (shown in FIG. 1) also supported by the frame 102. A glass or similar transparent material is provided in windows 116, enabling the operator sitting in the operator cabin 108 to view the surroundings of the machine 100.

The machine 100 is maneuvered from one location to another via one or more traction devices 104. Information regarding the location of the machine 100, the position of the work tool 112, or position of any other component or system associated with the machine 100 may be obtained through a position detection module 118.

The position detection module 118 may be included in the machine 100 (shown in FIG. 2). The position detection module 118 is configured to provide location of the machine 100 or work tool 112 or any other associated component. The position detection module 118 may be any one or a combination of a Global Positioning System, a Global Navigation Satellite System, a Pseudolite/Pseudo-Satellite, any other Satellite Navigation System, an Inertial Navigation System or any other known position detection system known in the art.

The machine 100 further includes an unmanned aerial vehicle 120 (hereafter referred to as UAV). The UAV 120 may be configured to move around the machine 100 and provide images of surrounding of the machine 100 to an operator. As shown in FIG. 1, the UAV 120 is configured to be positioned above the work tool 112 to provide images of the work tool. The UAV 120 includes a monitoring device 122 and a location detection module 130. The location detection module 130 is configured to provide location of the UAV 120 any other associated component. The location detection module 130 may be any one or a combination of a Global Positioning System, a Global Navigation Satellite System, a Pseudolite/Pseudo-Satellite, any other Satellite Navigation System, an Inertial Navigation System or any other known position detection system known in the art.

The monitoring device 122 is configured to capture images of the surrounding of the machine such as work tool 112, a blind spot around the machine 100 as desired by the operator. The monitoring device 122 may be any image capturing device. In the embodiments illustrated, the monitoring device 122 is a camera. In an alternate embodiment, the monitoring device 122 may be a video camera, monocular camera, infrared camera or any other imaging device known in the art configured to provide a still image or a moving image. The operator may access the image feed through a display unit 124.

The display unit 124 may be included in the operator cabin 108, as shown in FIG. 2. The display unit 124 may be remotely connected with the monitoring device 122. Images from the monitoring device 122 are transmitted to the display unit 124. In another embodiment, the display unit 124 is in communication with the monitoring device 122 using a wire. In an alternate embodiment, the display unit 124 may also be any portable device which may be operated by a personnel present outside the machine 100. Further, in another embodiment, the display unit 124 may be positioned in a central station for remotely controlled machines.

Referring to FIG. 1 and FIG. 2, the UAV 120, the monitoring device 122, the position detection module 118, the location detection module 130 and the display unit 124 may be communicably coupled to a controller 128. The controller 128 may be a microprocessor or any other electronic device to control a plurality of devices. In an embodiment, the controller 128 may be an electronic control module (ECM). The controller 128 may be configured to receive signals from various electronic devices, but not limited to, the UAV 120, the position detection module 118 and monitoring device 122. Correspondingly, the controller 128 may further communicate with the display unit 124. In the embodiment illustrated, the controller 128 is positioned on the machine 100. In other embodiments, the controller 128 may be remotely placed.

The controller 128 is configured to control the UAV 120. The controller 128 launches the UAV 120 from a base station 126 on the command of the operator. The UAV 120 may be positioned by the operator at a desired location to provide a desired view of the work tool 112 or machine 100 surroundings on the display unit 124. In the present embodiment, the UAV 120 is positioned such that it has a vantage of the work tool 112 associated with the machine 100. The operator may position the UAV 120 with respect to the work tool by moving the UAV 120 though a joystick or any operator interface 114. In another embodiment, the operator may input position coordinates of the desired location, to achieve the desired view. Once the UAV 120 is positioned at desired location, the controller 128 is further configured to maintain a constant distance between the machine 100 and the UAV 120 using the position detection module 118 and the location detection module 130. The position detection module 118 and the location detection module 130 are configured to send the location of the machine 100 and UAV 120 to the controller 128 respectively.

The controller 128 receives latitude, longitude, and elevation coordinates of the machine 100 via the position detection module 118. The coordinates received from the position detection module 118 are processed and the location of the machine 100 is determined. The controller 128 further receives the coordinates of the UAV 120 and determines the location of the UAV 120. The controller 128 determines the distance between the UAV 120 and the machine 100 and maintains this distance when the machine is moving. In an alternate embodiment, controller 128 may be configured to determine the current position of the work tool and adjust position of the UAV 120 to get the desired work tool vantage. The UAV 120 may be fixed at a constant distance with respect to the work tool 112.

The controller 128 transfers the images of the work tool 112 and surroundings of work tool 112 from the monitoring device 122 to the display unit 124. The controller 128 may also change the orientation of the monitoring device 122 to achieve a particular view of the work tool 112 and surroundings of work tool 112. Image feed provided by the monitoring device 122 may be still images or moving images. In an alternate embodiment, the monitoring device may provide real-time images. The display unit 124 displays the vantage of the work tool 112 and surroundings of the work tool 112. More particularly, the vantage of the work tool 112 includes a front-view of the work tool 112 and interior-view of the work tool 112, which are not visible to the operator from the operator cabin 108. In an alternate embodiment, the monitoring device 122 may also provide a view of the machine 100 or surroundings of the machine 100.

The UAV 120, after use for extended periods may result in complete battery discharge. When the battery power of the UAV 120 is low, a signal is sent to the controller 128. The controller 128 may automatically return the UAV 120 to the base station 126 for charging of battery.

The UAV 120 is placed on the base station 126 when the machine 100 is not performing any operation. The base station 126 may be located on the machine 100. The base station 126 may be located on the operator cabin 108, hood, or any other suitable location on or inside the machine 100. In an alternate embodiment, the base station 126 may be located at a remote location.

As shown in FIG. 1, the base station 126, mounted on the machine 100, is disclosed. The base station 126 may have the facility to provide radio signals, infrared guiding beams or other emissions in order to assist the UAV 120 in locating the base station 126. The base station 126 may be provided with a power source to charge the UAV 120.

The UAV 120 may be charged inductively. This may include a charging station configured to generate electromagnetic field. The charging station and the UAV 120 may include an induction coil. Energy generated by the electromagnetic field is sent through an inductive coupling to the UAV 120, which may be used to charge batteries of the UAV 120. In another embodiment, overhead power lines may spread over the work site. The wires may create an electromagnetic field which would further charge the UAV 120 inductively. In various other embodiments, the UAV 120 may be recharged at a central station. The discharged batteries of the UAV 120 can be manually exchanged with the fully charged batteries. In another embodiment, plurality of UAVs 120 may be deployed at a work site. Plurality of UAVs 120 are configured to provide a continuous footage of the work tool 112 and its surrounding in case of battery discharge. When the battery power of the UAV 120 is low, the UAV 120 is returned to the base station 126 and simultaneously another UAV 120 may take the position of the previous UAV 120 to provide a continuous footage to the operator.

Thus, the operator may visually monitor the work tool 112 and surroundings of the work tool 112 from inside the operator cabin 108 and notice the status of the work tool 112 and has an indication whether the work tool 112 is in a correct position.

### INDUSTRIAL APPLICABILITY

Machines such as wheel loader, dozers, motor graders, compactors, pavers and profilers and the like, may be used for various operations in a work site such as transportation, loading or surface altering to name a just a few. Such machines typically have an operator cabin and window panes so that the operator can visualize the work tool. However, the operator is not able to get a clear view of the work tool and the work tool surroundings from the operator cabin i.e. the operator may only be able to view only the backside of the work tool. The operator may have to step out of the machine to check the status of the tool.

In an aspect of the present disclosure, an UAV 120 including a monitoring device 122 is configured to provide the vantage of the work tool 112 to the operator. The monitoring device 122 may be communicably connected with a display unit 124 via a controller 128. The UAV 120 and the monitoring device 122 provides a clear view of the work tool 112 and surroundings of the work tool 112. A controller 128 is configured to control the UAV 120, the monitoring device 122 and the display unit 124. The operator determines the location of the UAV 120, so that monitoring device 122 provides the required vantage of the work tool 112 and surroundings of the work tool 112. Particularly, the monitoring device 122 may provide a front view or an interior view of the work tool 112 (in the present embodiment, the work tool is bucket). The controller 128 further transfers the image feed from the monitoring device 122 to the display unit 124.

The controller 128 is configured to maintain a constant distance between the UAV 120 and the machine 100 or work tool 112. When the machine 100 is in operation, the machine 100 or the work tool 112 may change position. The controller 128 automatically adjusts the position of the UAV 120 in such a manner that the constant distance is maintained between the UAV 120 and the machine 100 or work tool 112. For example, when the work tool 112 is lifted, the controller 128 also moves the UAV 120 such that the monitoring device 122 provides the same images i.e. the front view and the interior view of the work tool 112, which were being provided to the operator earlier. This may be less cumbersome for the operator as the operator may not have to change the position or orientation of the UAV 120 manually.

The UAV 120, after use for extended periods may result in complete battery discharge. The UAV 120 may automatically return to the base station 126, in case of battery discharge. A plurality of UAVs 120 may be deployed at the work site. When the UAV 120 is recovered back on the base station 126, simultaneously another UAV 120 may take the position of the previous UAV 120 to provide a continuous footage to the operator. Thus, operator may get a continuous view of the work tool 112 or machine 100 and its surrounding without any interruptions.

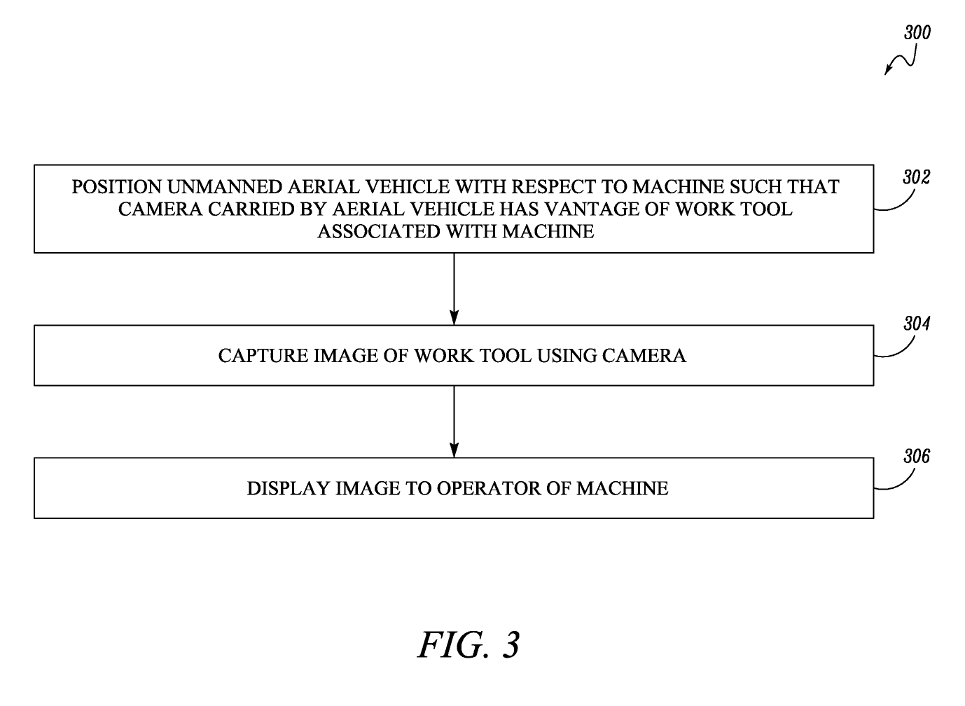

Further, the present disclosure provides a method 300 for providing vantage of the work tool 112 of the associated machine 100 will now be described in detail with reference to FIG. 3. The operator determines the location of the UAV 120 such that the monitoring device 122 (in the present embodiment, monitoring device is a camera) carried by the UAV 120 has a vantage of the work tool 112 associated with the machine 100. The controller 128 maintains the position of the UAV 120 with respect to the machine 100 so that operator may continue to get the desired view of the work tool 112 (step 302).

The method 300 further includes a step 304 in which the monitoring device 122 captures the images of the work tool 112 and provides a continuous image feed. The controller 128 directs the images from monitoring device 122 to the display unit 124. In another embodiment, the images of the work tool 112 are fed to the controller 128. The controller 128 further transfers the images from the UAV 120 to the display unit 124 (step 306).

While aspects of the present disclosure have seen particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method, comprising:
positioning an unmanned aerial vehicle with respect to a machine such that a camera carried by the unmanned aerial vehicle has a vantage of a work tool associated with the machine;
capturing an image of the work tool using the camera; and
displaying the image to an operator of the machine.

2. The method of claim 1, wherein the work tool is a bucket and wherein the vantage includes a view of the interior of the bucket.

3. The method of claim 1, wherein the vantage includes a view of the front of the work tool.

4. The method of claim 1, wherein the image includes at least one of a still image and a moving image.

5. The method of claim 1, wherein the machine includes an operator cabin and displaying the image includes displaying the image on a display unit positioned within the operator cabin.

6. The method of claim 1, further comprising launching the unmanned aerial vehicle from a base station associated with the machine before positioning the unmanned aerial vehicle.

7. The method of claim 1, further comprising landing the unmanned aerial vehicle on a base station associated with the machine after positioning the unmanned aerial vehicle.

8. The method of claim 1, further comprising charging the unmanned aerial vehicle on a base station associated with the machine.

9. The method of claim 1, wherein the image is a real-time image.

10. The method of claim 1, wherein positioning the unmanned aerial vehicle includes moving the unmanned aerial vehicle in response to movement of the work tool.

11. The method of claim 1, wherein plurality of unmanned aerial vehicles are deployed to provide continuous image feed in case of battery discharge.

12. A machine comprising:
a work tool;
an unmanned aerial vehicle including a camera, the camera is configured to capture an image of the work tool;
a display unit to display the image to an operator of the machine; and
a controller communicably coupled to the unmanned aerial vehicle, the controller configured to launch the unmanned aerial vehicle and determine a position of the unmanned aerial vehicle relative to the machine such that the camera carried by the aerial vehicle has a vantage of the work tool associated with the machine, the controller is further configured to display the images of the work tool to the operator through the display unit.

13. The machine of claim 12, wherein the work tool is a bucket and wherein the vantage includes a view of the interior of the bucket.

14. The machine of claim 12, wherein the vantage includes a view of the front of the work tool.

15. The machine of claim 12, wherein the image includes at least one of: a still image and a moving image.

16. The machine of claim 12, wherein the machine further includes an operator cabin and a display unit within the operator cabin configured to display images.

17. The machine of claim 12, wherein the unmanned aerial vehicle is launched from a base station associated with the machine before positioning the unmanned aerial vehicle.

18. The machine of claim 12, further comprising landing the unmanned aerial vehicle on a base station associated with the machine after positioning the unmanned aerial vehicle.

19. The machine of claim 12, further comprising charging the unmanned aerial vehicle on a base station associated with the machine.

20. The machine of claim 12, wherein positioning the unmanned aerial vehicle includes moving the unmanned aerial vehicle in response to movement of the work tool.
